(19) United States
(12) Patent Application Publication
(10) Pub. No.: US 2008/0317803 A1
(43) Pub. Date: Dec. 25, 2008

(54) Aqueous Rodenticide Formulations

(75) Inventors: Jurgen Jakob, Rodersheim-Gronau (DE); Andrej Brejc, Weisenheim am Berg (DE); Matthias Bratz, Maxdorf (DE)

Correspondence Address: BRINKS, HOFER, GILSON & LIONE, 2801 SLATER ROAD, SUITE 120, MORRISVILLE, NC, 27560, US

(73) Assignee: BASF SE, Ludwigshafen (DE)

(21) Appl. No.: 12/094,037

(22) PCT Filed: Nov. 14, 2006
(86) PCT No.: PCT/EP2006/068453

§ 371 Date: May 16, 2008

(30) Foreign Application Priority Data
Nov. 18, 2005 (EP) 05025204.8

(51) Int. Cl. A01N 25/08; A01P 11/00

(52) U.S. Cl. 424/410

(57) ABSTRACT

The present invention comprises novel aqueous rodenticide formulations, cereal grains treated with these formulations, and methods of controlling rodents based on these formulations.

The present invention comprises novel aqueous rodenticide formulations, cereal grains treated with these formulations, and methods of controlling rodents based on these formulations.

Aqueous rodenticide formulations with which cereal grains can be treated for the preparation of suitable bait formulations are as the result of their easy handling an attractive alternative for the skilled worker to the use of powder formulations since with baits treated with such formulations there is a risk of the active substance being released from the bait into the environment as the result of abrasion or undesired displacement.

Moreover, rodenticide-comprising treatment formulations must meet exacting requirements: when applied to the bait, which, for example, may take the form of cereal grains, they should, on the one hand, bring about the best possible adhesion of the active substance on the bait because of the toxicity of the active substance; on the other hand, any dust formation when the treated product is used or processed should be as low as possible.

The object of the present invention was thus to provide rodenticide formulations which, when cereal grains are treated with them, bring about the best possible adhesion of the active substance on the cereal grain and/or in which the dust formation when the treated product is used or processed is as low as possible.

The object was achieved by providing an aqueous rodenticide formulation comprising

(a) at least one rodenticide;

(b) at least one polyol;

(c) a sticker; and

(d) a monosaccharide and/or a disaccharide and/or an oligosaccharide.

An advantage of these formulations according to the invention is additionally the fact that these formulations can, in principle, manage without any solvent, which is desirable for odor and safety reasons.

Naturally, odorless and flavorless solvents may additionally be employed as an option. Butyrolactone or caprolactone may be mentioned by way of example, but not by limitation. Suitable amounts are 0-10% by weight, preferably 1 to 7% by weight, especially preferably 2 to 6% by weight.

The monosaccharide and/or disaccharide and/or oligosaccharide content is from 10% by weight to 50.0% by weight, preferably from 10.0% to 35.0% by weight, especially preferably 15.0-25.0% by weight.

The rodenticide content is from 0.01% by weight to 30% by weight, preferably from 0.01% to 1% by weight, especially preferably 0.02-0.2% by weight.

The polyol content is from 1% by weight to 50% by weight, preferably from 1 to 20% by weight.

The sticker content is from 1% by weight to 30% by weight, preferably from 1 to 10% by weight, especially preferably from 1 to 5% by weight.

Suitable Rodenticides are

plant-based rodenticides such as scilliroside or strychnine;

coumarin rodenticides such as brodifacoum, bromadiolone, coumachlor, coumafuryl, coumatetralyl, difenacoum, difethialone, flocoumafen, warfarin;

indanedione rodenticides such as chlorophacinon, diphacinon, pindon; inorganic rodenticides such as arsenic oxide, potassium arsenite, sodium arsenite, thallium arsenite;

organophosphate rodenticides such as phosacetim;

pyrimidineamine rodenticides such as crimidine; thiourea rodenticides such as antu; urea rodenticides such as pyrinuron; various rodenticides such as bromethalin, chloralose, fluoroacetamide, flupropadin, sodium salts or potassium salts of hydrocyanic acid, norbornides and sodium fluoroacetate;

preferably the abovementioned coumarin rodenticides; especially preferably flocumafen and difenacum; very especially preferably flocumafen.

Suitable polyols are glycol, polyethylene glycol, glycerol, propylene glycol, dipropylene glycol, preferably glycerol.

The use of mono- and disaccharides is preferred within the scope of the present invention. The use of disaccharides is very especially preferred.

Suitable monosaccharides are glucose, fructose, galactose, preferably fructose.

Suitable disaccharides are sucrose, maltose, lactose, preferably sucrose (for example in pure form or as molasses, beet sugar)

A suitable oligosaccharide is starch.

Suitable stickers are ethylene oxide/propylene oxide copolymers, polyvinyl alcohol (e.g. Mowiol® 4-98, Clariant, Rhodoviol® 60-20, Rhone-Poulenc), polyvinylpyrrolidone (Sokalan® HP 50, BASF, Kollidon® 25, BASF, Luvitec® K 80, BASF Agrimer® A, ISP Global Techn), polyacrylates (e.g. Sokalan® PA 110 S, BASF), polymethyl methacrylates, water-soluble polyolefin derivatives such as polybutene derivatives, polyethylene oxides (e.g. polyethers) or polyisobutylene derivatives (e.g. copolymers of polyolefins and maleic anhydride derivatives (e.g. Densodrin BA® from BASF), polystyrene derivatives (e.g. copolymers of styrene and maleic anhydride derivatives or copolymers of styrene and acrylic acid derivatives or latex copolymers based on styrene/butadiene, obtainable for example as Semkote E-125, Uniqema) and also polyethyleneamines, polyethyleneamides, polyethyleneimines (e.g. Lupasol® BASF, Polymin® BASF), polyurethanes (Semkote E-105, Uniqema) polyvinyl acetate, Tylose and also of polyethylene wax (e.g. commercially available as Poligen®WE 7 BASF)

preferably,

ethylene oxide/propylene oxide copolymers, polyacrylates (e.g. Sokalan® PA 110 S, BASF), polymethyl methacrylates, water-soluble polyolefin derivatives such as polybutene derivatives, polyethylene oxides (e.g. polyethers) or polyisobutylene derivatives (e.g. copolymers of polyolefins and maleic anhydride derivatives (e.g. Densodrin BA® from BASF), polystyrene derivatives (e.g. copolymers of styrene and maleic anhydride derivatives or copolymers of styrene and acrylic acid derivatives or latex copolymers based on styrene/butadiene, obtainable for example as Semkote E-125, Uniqema) and also polyethyleneamines, polyethyleneamides, polyethyleneimines (e.g. Lupasol® BASF, Polymin® BASF), polyurethanes (Semkote E-105, Uniqema) polyvinyl acetate, and also of polyethylene wax (e.g. commercially available as Poligen®WE 7 BASF);

more preferably

ethylene oxide/propylene oxide copolymers, polyacrylates (e.g. Sokalan® PA 110 S, BASF), polymethyl methacrylates, polystyrene derivatives (e.g. copolymers of styrene and maleic anhydride derivatives or copolymers of styrene and acrylic acid derivatives or latex copolymers based on styrene/butadiene, obtainable for example as Semkote E-125, Uniqema) and also of polyethylene wax (e.g. commercially available as Poligen®WE 7 BASF).

Moreover, the formulations according to the invention can optionally also comprise further adjuvants such as, e.g. surfactants (such as wetters, stickers and dispersants), antifoams, thickeners, bactericides and colorants.

Examples of surfactants are alkali metal, alkaline earth metal, ammonium salts of lignosulfonic acid, naphthalenesulfonic acid, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers, furthermore condensates of sulfonated naphthalene and naphthalene derivatives with formaldehyde, condensates of naphthalene, or of naphthalenesulfonic acid, with phenol and formaldehyde, polyoxyethylene octylphenol ether, ethoxylated isooctylphenol, octylphenol, nonylphenol, alkylphenol polyglycol ethers, tributylphenyl polyglycol ether, tristearylphenyl polyglycol ether, alkyl-aryl polyether alcohols, alcohol and fatty alcohol ethylene oxide condensates, ethoxylated castor oil, polyoxyethylene alkyl ethers, ethoxylated polyoxypropylene, lauryl alcohol polyglycol ether acetal, sorbitol esters, lignin-sulfite waste liquors and methylcellulose.

Examples of thickeners (i.e. compounds which impart a pseudoplastic flow behavior to the formulation, i.e. high viscosity in the quiescent condition and low viscosity in the agitated state) are, for example, polysaccharides or organic layer-structured minerals such as xanthan gum (Kelzan® from Kelco), Rhodopol® 23 (Rhone Poulenc) or Veegum® (R.T. Vanderbilt) or Attaclay® (Engelhardt).

Examples of antifoams are silicone emulsions (such as, for example, Silikon® SRE, Wacker or Rhodorsil® from Rhodia), long-chain alcohols, fatty acids, organofluorine compounds and their mixtures.

Bactericides which may be present in the formulations according to the invention and which are suitable are all bactericides which are conventionally used for the formulation of agrochemical active substances such as, for example, bactericides based on dichlorophen and benzyl alcohol hemiformal. Examples of bactericides are Prox® from ICI or Acticide® RS from Thor Chemie and Kathon® from Rohm & Haas.

Colorants which are suitable are all colorants which are conventionally used for such purposes. Both pigments which are sparingly soluble in water and colorants which are soluble in water may be used. Examples which may be mentioned are the colorants known under the names Rhodamin B, C.I. Pigment Red 112 and C.I. Solvent Red 1, and pigment blue 15:4, pigment blue 15:3, pigment blue 15:2, pigment blue 15:1, pigment blue 80, pigment yellow 1, pigment yellow 13, pigment red 112, pigment red 48:2, pigment red 48:1, pigment red 57:1, pigment red 53:1, pigment orange 43, pigment orange 34, pigment orange 5, pigment green 36, pigment green 7, pigment white 6, pigment brown 25, basic violet 10, basic violet 49, acid red 51, acid red 52, acid red 14, acid blue 9, acid yellow 23, basic red 10, basic red 108 and their dyes such as, for example, Dispers Blau 69-0007; compounds available from BASF.

The present invention furthermore also comprises a method of preparing a bait formulation, wherein cereal grains are treated (dressed) with a formulation according to the invention.

The term cereal grains comprises any type of seed which are present as the intact grain, i.e. which are not crushed, chopped or divided.

The treatment/dressing can be carried out by methods with which the skilled worker is familiar (for example by spraying or immersing/incubating the cereal grains in, or with, the formulation according to the invention, if appropriate in a suitable device such as a continuously or batchwise operating seed-dressing apparatus). The formulation may be diluted with up to 7.5 g of water/kg cereal grains. The treated grains can optionally be dried.

Suitable cereal grains are barley, wheat, rice, maize, oats, rye, spelt, Grünkern, millet/sorghum, rapeseed and sunflowers, preferably wheat.

In a further embodiment, the present invention comprises methods of controlling rodents, wherein the above-described baits are placed at locations which are frequented by the abovementioned animals.

Besides rats and mice, the term rodents is also understood as meaning muskrats, preferably rats or mice, especially preferably rats.

To this end, it is possible, for example, to introduce the treated seed grains into suitable traps and to place them at exposed locations such as, for example, runs of rodents, holes in which the rodents dwell or at locations which are marked by their feces.

The traps should preferably be of such a type that the rat will definitely be aware of the grains. Checking the amount of bait occasionally allows conclusion on their effect and on the population of the animals.

### EXAMPLES

### Example 1

### Preparation of the Aqueous Formulation

A) Formulation 1

Storm® mastermix (40 g of a commercially available flocumafen formulation, Storm® 0.5% mastermix, comprising 5 g/kg flocumafen) were initially introduced together with 150 g of beet sugar, 100 g of glycerol, 50 g of the sticker Poligen WE 7 (polyethylene wax) and 648 g of water and dissolved, better: mixed, with stirring. Thereafter, 10 g of Dispers Blau were admixed and the batch was homogenized. 100 g of the pre-swelled xanthan gum (2% by weight of xanthan gum in water) and 2 g of the bactericide (Acticide MBS) were metered in. The resulting mixture was homogenized.

B) Formulation 2

Storm® mastermix (40 g of a commercially available flocumafen formulation, Storm® 0.5% mastermix, comprising 5 g/kg flocumafen) were initially introduced together with 200 g of beet sugar, 100 g of polyethylene glycol E400 Lutrol E 400; BASF, 100 g of the sticker Semkote E 125 (styrene/butadiene-based synthetic latex) and 408 g of water and dissolved with stirring. Thereafter, 50 g of Dispers Blau 69-0007 were admixed and the batch was homogenized. 100 g of the pre-swelled xanthan gum (2% by weight of xanthan gum in water) and 2 g of the bactericide (Acticide MBS) were metered in and the resulting mixture was homogenized.

### Example 2

### Treatment with the Formulations 1 and 2

Materials:

>2.5 g of water

1000 g of wheat

2.5-25 g of formulation A or formulation B

Preparation:

The wheat was introduced into a commercially available continuous or batchwise operating seed-dressing apparatus (batch dresser) (Concept ML 2000, from Satec). Thereafter, the formulation A or B was subsequently metered in under mild conditions (approx. 690 rpm), using a peristaltic pump or another metering unit. After a further 30 seconds, the treated grains are transferred into suitable containers and stored under dry conditions until packaged.

1-11. (canceled)

12: A cereal grain treated with an aqueous rodenticide formulation and dried, the formulation comprising
(a) at least one rodenticide;
(b) at least one polyol selected from the group consisting of glycol, polyethylene glycol, glycerol, propylene glycol and dipropylene glycol;
(c) at least one adhesive selected from the group consisting of polyethylene wax and styrene/butadiene latex copolymer based; and
(d) a saccharide selected from the group consisting of a monosaccharide and a disaccharide, wherein the content of the saccharide is from about 10.0 wt % to about 50.0 wt %.

13: The cereal grain according to claim 12, wherein the rodenticide content is from about 0.01% by weight to about 30% by weight.

14: The cereal grain according to claim 12, wherein the polyol content is from about 1% by weight to about 50% by weight.

15: The cereal grain according to claim 12, wherein the adhesive content is from about 2% by weight to about 30% by weight.

16: The cereal grain according to claim 12, wherein the rodenticide is flocumafen.

17: The cereal grain according to claim 12, wherein the polyol is glycerol.

18: The cereal grain according to claim 12, wherein the saccharide is a disaccharide.

19: The cereal grain according to claim 12, wherein the cereal grain is selected from the group consisting of barley, wheat, rice, maize, oats, rye, spelt, Grünkern, millet/sorghum, rapeseed, sunflower seed, and combinations thereof.

20: A process for preparing a bait formulation, comprising treating cereal grains with
an aqueous rodenticide formulation comprising
at least one rodenticide,
at least one polyol,
a sticker, and
a saccharide selected from the group consisting of monosaccharide, a disaccharide, an oligosaccharide, or combinations thereof; and
drying to afford a bait formulation.

21: The process according to claim 20, wherein the cereal grains are barley, wheat, rice, maize, oats, rye, spelt, Grünkern, millet/sorghum, rapeseed, a sunflower seed, or combinations thereof.

22: A method of controlling rodents, wherein a bait comprising cereal grains according to claim 12 is placed at locations which are frequented by the rodents.
